(19) United States
(12) Patent Application Publication
(10) Pub. No.: US 2025/0166000 A1
(43) Pub. Date: May 22, 2025

(54) DELIVERY ASSISTANCE SYSTEM, DELIVERY ASSISTANCE METHOD, AND RECORDING MEDIUM

(71) Applicant: NEC Corporation, Minato-ku, Tokyo (JP)

(72) Inventors: Yosuke UMEDA, Tokyo (JP); Yuma KAMIMOTO, Tokyo (JP); Kohei SUGA, Tokyo (JP)

(73) Assignee: NEC Corporation, Minato-ku, Tokyo (JP)

(21) Appl. No.: 18/727,369

(22) PCT Filed: Mar. 25, 2022
(86) PCT No.: PCT/JP2022/014286

§ 371 Date: Jul. 9, 2024

(51) Int. Cl. G06Q 30/0207; G06Q 10/083

(52) U.S. Cl. CPC G06Q 30/0207; G06Q 10/083

(57) ABSTRACT

This delivery assistance system comprises: a delivery acquisition unit; a loading rate calculation unit; a determination unit; a deciding unit; and an output control unit. The delivery acquisition unit acquires information regarding the delivery of load from each of a plurality of shippers. The information regarding the delivery of load includes the load amount. The loading rate calculation unit calculates the loading rate of load delivered by the same delivery means at one time, on the basis of the information regarding delivery. The determination unit determines whether the calculated loading rate is equal to or greater than a predetermined value. The deciding unit decides incentives for a plurality of shippers, when the loading rate of load is equal to or greater than the predetermined value.

### TECHNICAL FIELD

The present disclosure relates to a delivery assistance system and the like.

### BACKGROUND ART

There is a joint delivery in which a plurality of consignors carries and delivers load loaded on delivery means such as the same truck.

For example, PTL 1 discloses a technique in which truck information with a margin for loading is disclosed on the Internet to open an additional consignor and return a profit due to a reduction in delivery cost by joint delivery to the consignor according to the cargo amount.

For example, PTL 2 describes a technique of calculating a loading rate, and assessing an increase angle of a loading rate angle on a graph obtained by graphing a loading rate and time when the calculated loading rate is within a loading rate designated by a user.

### CITATION LIST

### Patent Literature

PTL 1: JP 2018-180893 A
PTL 2: JP 2015-113187 A
PTL 3: JP 2008-097102 A

### SUMMARY OF INVENTION

### Technical Problem

For example, a distribution company wants to promote joint delivery, but there is a problem that it is difficult to have a consignor with a large volume participating in the joint delivery since the consignor can arrange a truck or the like alone.

An object of the present disclosure is to provide a delivery assistance system or the like that promotes participation in joint delivery.

### Solution to Problem

A delivery assistance system according to an aspect of the present disclosure includes a delivery acquisition means for acquiring, from each of a plurality of consignors, information about delivery of load including a load amount, a loading rate calculation means for calculating a loading rate of load delivered by a same delivery means at a time based on the information about delivery, an assessment means for assessing whether the calculated loading rate is equal to or more than a predetermined value, a determination means for determining an incentive to the plurality of consignors in a case where the loading rate is equal to or more than the predetermined value, and an output control means for presenting the determined incentive.

A delivery assistance method according to an aspect of the present disclosure includes acquiring, from each of a plurality of consignors, information about delivery of load including a load amount, calculating a loading rate of load delivered by a same delivery means at a time based on the information about delivery, assessing whether the calculated loading rate is equal to or more than a predetermined value, determining an incentive to the plurality of consignors in a case where the loading rate is equal to or more than the predetermined value, and presenting the determined incentive.

A program according to an aspect of the present disclosure causes a computer to execute the steps of acquiring, from each of a plurality of consignors, information about delivery of load including a load amount, calculating a loading rate of load delivered by a same delivery means at a time based on the information about delivery, assessing whether the calculated loading rate is equal to or more than a predetermined value, determining an incentive to the plurality of consignors in a case where the loading rate is equal to or more than the predetermined value, and presenting the determined incentive.

The program may be stored in a non-transitory computer-readable recording medium.

### Advantageous Effects of Invention

According to the present disclosure, it is possible to promote participation in joint delivery.

### BRIEF DESCRIPTION OF DRAWINGS

FIG. 1 is a block diagram illustrating a configuration example of a delivery assistance system according to the first example embodiment.

FIG. 2 is a flowchart illustrating an operation example of the delivery assistance system according to the first example embodiment.

FIG. 3 is an explanatory diagram illustrating an example of joint delivery.

FIG. 4 is an explanatory diagram illustrating an example of connection between the delivery assistance system and another device.

FIG. 5 is a block diagram illustrating a configuration example of a delivery assistance system according to the second example embodiment.

FIG. 6 is an explanatory diagram illustrating an example of a screen for receiving information about delivery.

FIG. 7 is an explanatory diagram illustrating a display example of an incentive.

FIG. 8 is a flowchart illustrating an operation example of the delivery assistance system according to the second example embodiment.

FIG. 9 is a flowchart illustrating another operation example by the delivery assistance system according to the second example embodiment.

FIG. 10 is an explanatory diagram illustrating a hardware configuration example of a computer.

### EXAMPLE EMBODIMENT

Hereinafter, example embodiments of a delivery assistance system, a delivery assistance method, a program, and a non-transitory recording medium recording the program according to the present disclosure will be described in detail with reference to the drawings. The present example embodiment does not limit the disclosed technology.

### First Example Embodiment

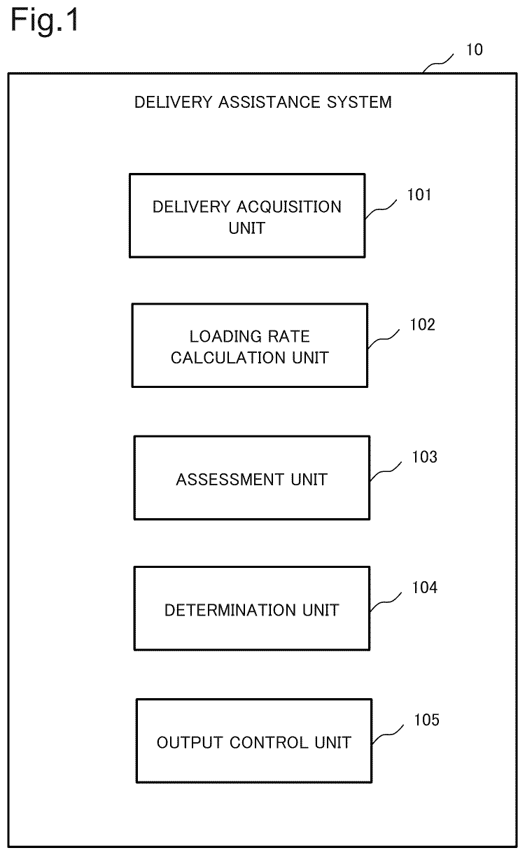

First, in the first example embodiment, a basic function of the delivery assistance system will be described. FIG. 1 is a block diagram illustrating a configuration example of a delivery assistance system according to the first example embodiment. A delivery assistance system 10 assists joint delivery.

The delivery assistance system 10 includes a delivery acquisition unit 101, a loading rate calculation unit 102, an assessment unit 103, a determination unit 104, and an output control unit 105.

The delivery acquisition unit 101 acquires information about delivery of load including the load amount from each of a plurality of consignors. The load amount may be, for example, the load amount predicted by the consignor. The prediction here may be manual empirical prediction, prediction using machine learning, or the like, and is not particularly limited in technique, accuracy, or the like. The load amount may be, for example, a load amount determined by a consignor.

The type of the load amount may be different according to the characteristics of the load, and the spatial amount of load, the weight amount of load, a combination thereof, and the like are not particularly limited. For example, a weight amount is used as the load amount such as a steel material. In a case where the load amount is a spatial amount of load, the unit of the load amount may be an existing unit such as a volume, the number in a specific load, or the like, and is not particularly limited. In a case where the load amount is a weight amount, the unit of the load amount may be an existing unit such as weight, and is not particularly limited.

As a method by which the delivery acquisition unit 101 acquires the information about delivery of the load, the delivery acquisition unit 101 may receive the information about delivery of the load. More specifically, for example, the delivery acquisition unit 101 receives information about delivery of the load by the operation by the consignor. For example, the operation by the consignor may be performed via a terminal device of the consignor. Alternatively, for example, the delivery acquisition unit 101 may acquire information about delivery of an object from a database or the like.

The loading rate calculation unit 102 calculates the loading rate of load delivered by the same delivery means at a time based on the information about delivery. The delivery means is not particularly limited, and examples thereof include a vehicle, a ship, an airplane, and a drone. The vehicle is a truck or a bicycle, and not particularly limited.

As a premise for calculating the loading rate, it is assumed that which load is to be jointly delivered to the same delivery means at a time is determined based on the received information about delivery. Since an existing technique may be used as this determination method, description thereof is omitted. A method by which the loading rate calculation unit 102 calculates the loading rate may be performed using an existing technique, and is not particularly limited. Specifically, for example, the loading rate calculation unit 102 may calculate the loading rate by the ratio of the total load amount of load identified by the information about delivery of the plurality of consignors to the load amount that can be delivered by the same delivery means. The loading rate may be a usage amount with respect to a space in which the delivery means can be loaded, a usage amount with respect to a weight for which the delivery means can be loaded, or the like.

The assessment unit 103 assesses whether the calculated loading rate is equal to or more than a predetermined value. The predetermined value is not particularly limited, but may be, for example, an average loading rate or a target value determined by a distribution company. The predetermined value may be a fixed value such as 80%, or may be a value that changes depending on the season, the day of the week, or the like.

The determination unit 104 decides incentives for a plurality of consignors, when the loading rate is equal to or more than the predetermined value. The type of incentive is not particularly limited, such as a discount or a point. For example, in a case where the incentive is a discount, the incentive may be a discount of the current delivery, a discount of the next delivery, or a discount of the contract fee related to the joint delivery, and is not particularly limited. The type of incentive may be different or the same for each consignor. The current delivery is a delivery for which the loading rate is calculated. The next delivery is a delivery performed after the delivery for which the loading rate is calculated. The term of the contract for joint delivery is not particularly limited, such as monthly or yearly.

Specifically, for example, the determination unit 104 may determine the same incentive to a plurality of consignors. For example, the determination unit 104 may determine different incentives for each of a plurality of consignors.

The output control unit 105 presents the determined incentive. For example, the output control unit 105 presents an incentive to the consignor. A method by which the output control unit 105 presents an incentive to the consignor is not particularly limited. For example, as a method of presenting an incentive, the output control unit 105 may notify the consignor of the incentive using an electronic message, an electronic mail, or the like. Alternatively, as a method of presenting an incentive, the output control unit 105 may output an incentive to a terminal device of a consignor. Specifically, for example, the output control unit 105 may display an incentive on a display device of a terminal device of a consignor, for example. Alternatively, the output control unit 105 may output a voice to a voice output device of a terminal device of the consignor, for example.

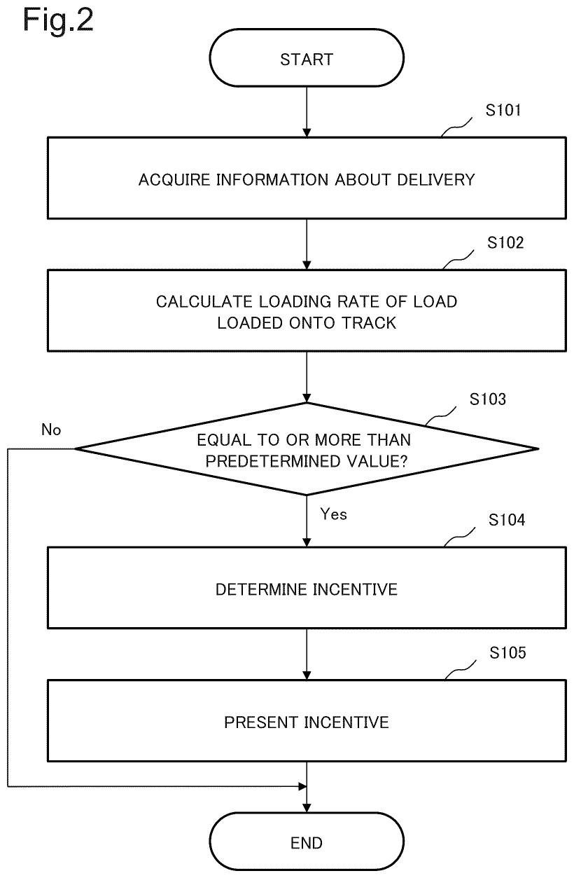

FIG. 2 is a flowchart illustrating an operation example of the delivery assistance system 10 according to the first example embodiment. The delivery acquisition unit 101 receives information about delivery of the load from each of a plurality of consignors (step S101).

The loading rate calculation unit 102 calculates the loading rate of load delivered by the same delivery means based on the information about delivery (step S102).

The assessment unit 103 assesses whether the calculated loading rate is equal to or more than a predetermined value (step S103). In a case where the calculated loading rate is equal to or more the predetermined value (step S103: Yes), the determination unit 104 determines an incentive to a plurality of consignors in a case where the loading rate is equal to or more than the predetermined value (step S104). The output control unit 105 presents the determined incentive (step S105). Then, the delivery assistance system 10 ends the process.

On the other hand, in a case where the calculated loading rate is less than the predetermined value (step S103: No), the delivery assistance system 10 ends the process.

As described above, in the first example embodiment, the delivery assistance system 10 receives information about delivery of load, calculates a loading rate of load loaded onto the same delivery means at a time, and determines and presents an incentive when the loading rate is high. As a result, it is possible to encourage participation in the joint delivery. When the joint delivery is more used and the loading rate is improved, the number of times of use of the delivery means with respect to the load amount can be reduced. Therefore, in a case where a delivery means that discharges carbon dioxide is used, it is possible to reduce the amount of carbon dioxide emission. Traffic congestion can be alleviated.

### Second Example Embodiment

Next, the second example embodiment will be described in detail with reference to the drawings. In the second example embodiment, an example in which information about delivery is acquired and an incentive is exemplified will be described in more detail. In the second example embodiment, a truck will be described as an example of the delivery means. Hereinafter, description of content overlapping with the above description will be omitted to the extent that the description of the second example embodiment is not unclear.

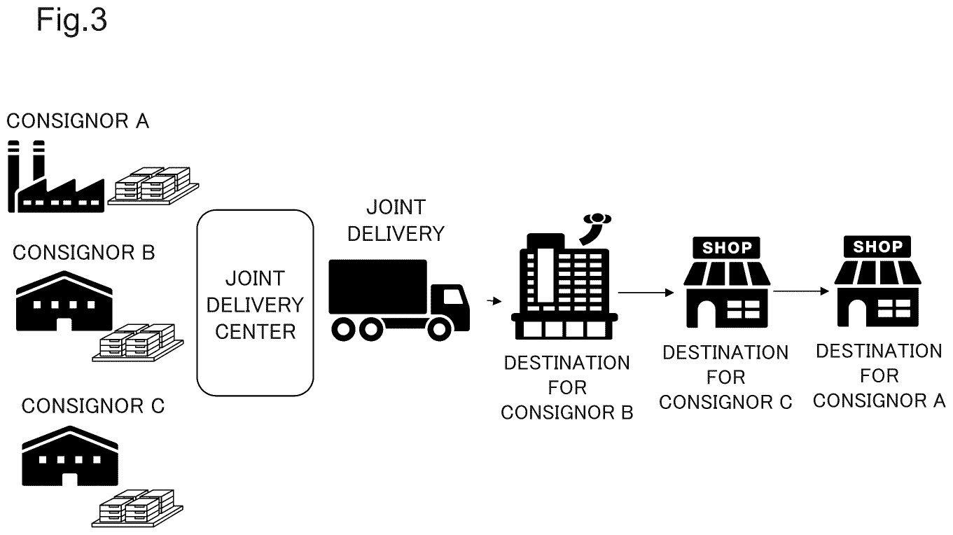

FIG. 3 is an explanatory diagram illustrating an example of joint delivery. For example, in FIG. 3, in a joint delivery center, a distribution company collects and delivers load from each of a plurality of consignors. In the example of FIG. 3, a distribution company having a consignor A, a consignor B, and a consignor C as a consignor loads and delivers load collected from each of a plurality of consignors onto the same truck. This delivery is joint delivery. Then, the truck delivers load to a destination of the load of each consignor. The destinations of the load of each consignor may be the same. The destination is not limited to a specific destination, and may be a destination direction or the like. The destination here is not limited to the final destination, and may be a transit point on the way. The joint delivery of FIG. 3 is an example, and for example, a joint delivery such as a milk run method is collected from a plurality of companies by one truck may be used.

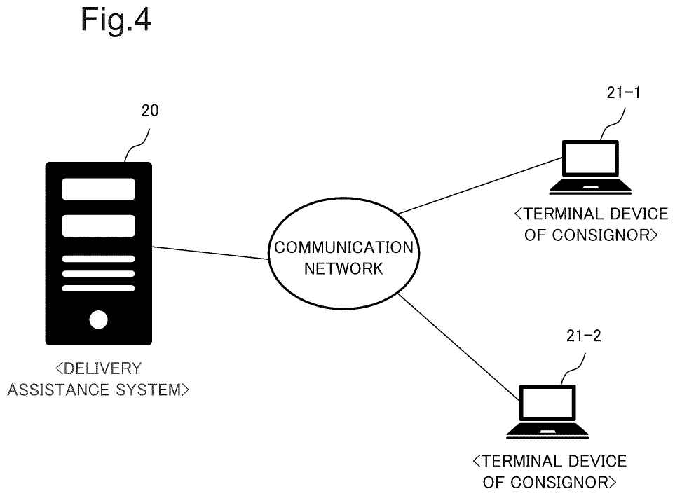

FIG. 4 is an explanatory diagram illustrating an example of connection between the delivery assistance system and another device. For example, a delivery assistance system 20 is connected to a terminal device 21 or the like of each consignor via a communication network NT. In FIG. 4, one communication network NT is exemplified for ease of description, but the delivery assistance system 20 may be connected by different communication networks NT for respective devices, and is not particularly limited.

While a terminal device 21-1 and a terminal device 21-2 of the consignors are illustrated in FIG. 4, the terminal device 21 of the consignor may be provided for each consignor, and the number of terminal devices 21 of the consignor is not particularly limited. In a case where the terminal device 21 of the consignor is not uniquely identified, it is simply described as the terminal device 21. The type of the terminal device 21 of the consignor is a smartphone, a tablet-type device, and a personal computer (PC), and not particularly limited.

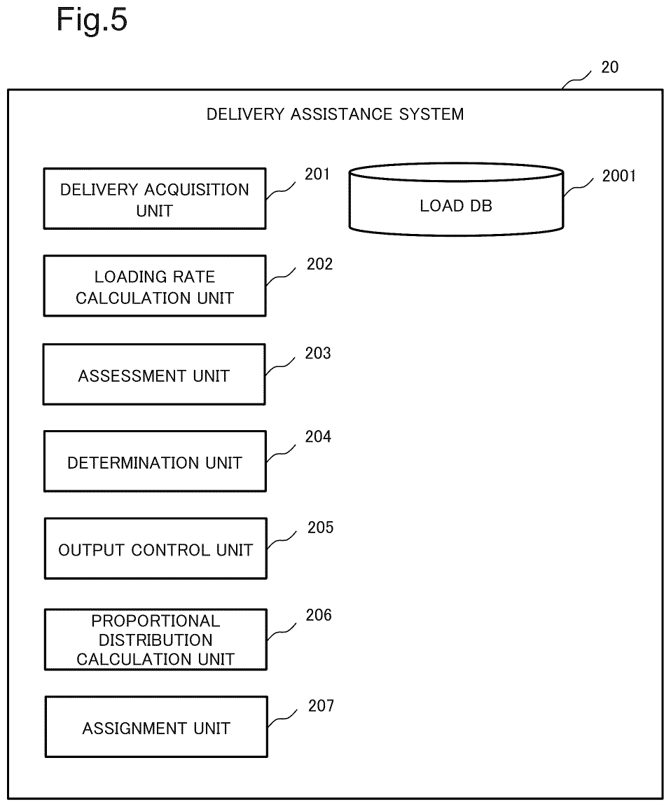

FIG. 5 is a block diagram illustrating a configuration example of the delivery assistance system 20 according to the second example embodiment. The delivery assistance system 20 includes a delivery acquisition unit 201, a loading rate calculation unit 202, an assessment unit 203, a determination unit 204, an output control unit 205, a proportional distribution calculation unit 206, and an assignment unit 207.

In the second example embodiment, a proportional distribution calculation unit 206 and an assignment unit 207 are further added to the delivery assistance system 20 in the first example embodiment. The delivery acquisition unit 201 has the function of the delivery acquisition unit 101 according to the first example embodiment as a basic function. The loading rate calculation unit 202 has the function of the loading rate calculation unit 102 according to the first example embodiment as a basic function. The assessment unit 203 has the function of the assessment unit 103 according to the first example embodiment as a basic function. The determination unit 204 has the function of the determination unit 104 according to the first example embodiment as a basic function. The output control unit 205 has the function of the output control unit 105 according to the first example embodiment as a basic function.

The delivery assistance system 20 may include a load database (DB) 2001. The load DB stores information about delivery of load. The load DB 2001 may store consignor identification information for identifying a consignor and information about delivery of load in association with each other. As described in the first example embodiment, the information about delivery of the load may include, for example, a predicted amount of load or a confirmed amount of load. The load DB 2001 may store the load amount predicted by the consignor and the date when the consignor provided this amount to the distribution company. The load DB 2001 may store the load amount determined by the consignor and the date when the consignor provided this amount to the distribution company. Furthermore, the information about delivery of the load may be a value of each item regarding the delivery of the load.

The expression form of the item is not particularly limited. The item includes a delivery date, a destination, time designation, temperature designation, packing designation, and the like, and is not particularly limited.

Next, respective function units will be described.

<Incentive in a Case where Loading Rate is High>

First, an example of presenting an incentive when the loading rate is high will be described.

The delivery acquisition unit 201 acquires information about delivery of load including the load amount from each of a plurality of consignors. As described in the first example embodiment, a method by which the delivery acquisition unit 201 acquires information about delivery of load is not particularly limited.

As described above, the load amount may be a predicted load amount or a confirmed load amount. In general, it is assumed that the predicted load amount is provided by a consignor, for example, a week before the delivery date, a few weeks before the delivery date, or the like. On the other hand, in general, it is assumed that the confirmed load amount is provided by the consignor on the day before the delivery date, for example. Therefore, the delivery acquisition unit 201 may receive the predicted load amount of the consignor and the confirmed load amount of the consignor from the consignor at different timings. The delivery acquisition unit 201 may store the received load amount together with the received date in the load DB 2001.

An example in which information about delivery of load is received by operation by the consignor via the terminal device 21 of the consignor will be described. For example, the output control unit 205 may display a screen for receiving information about delivery on a display device of the terminal device 21 of the consignor.

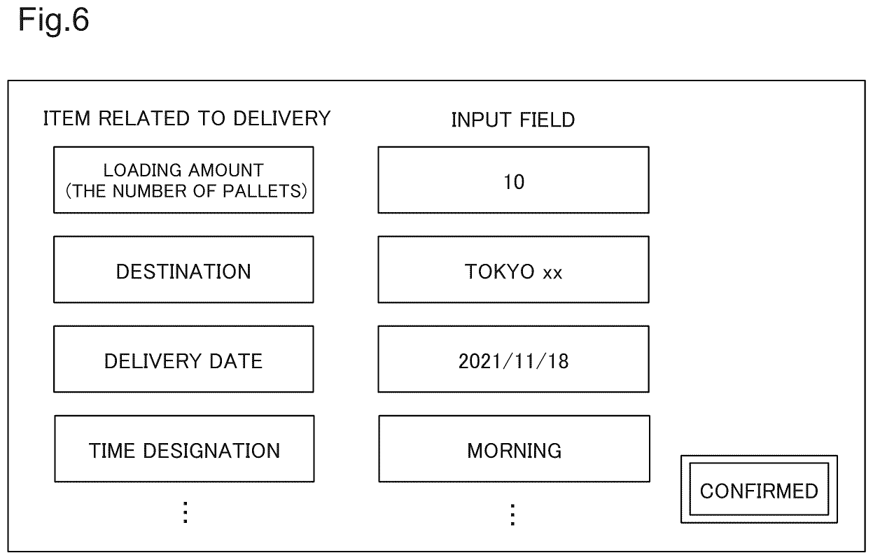

FIG. 6 is an explanatory diagram illustrating an example of a screen for receiving information about delivery. The terminal device 21 displays a screen for receiving information about delivery. In FIG. 6, the information about delivery is a value of an item regarding the delivery. On the screen of FIG. 6, a loading amount, a destination, a delivery date, time designation, and the like are displayed as items related to delivery. In FIG. 6, as an example, a loading amount is indicated as the load amount, and the number of pallets is indicated as a unit of the loading amount. The screen of FIG. 6 includes an input field in which a value of an item can be input for each item.

In FIG. 6, as an example, the loading amount “10”, the destination “Tokyo xx”, the delivery date “Nov. 18, 2021”, and the time designation “morning” are input by the operation by the consignor. The screen of FIG. 6 further includes a “confirmed” button. When the “confirmed” button is tapped by the operation by the consignor, the delivery acquisition unit 201 receives a value input in each input field. More specifically, for example, when the “confirmed” button is tapped by the operation by the consignor, the terminal device 21 transmits the value input in each input field to the delivery assistance system 20. The terminal device 21 may transmit the input value together with the consignor identification information capable of uniquely identifying the consignor. Then, the delivery acquisition unit 201 can acquire the input value as the information about delivery by receiving the input value.

The loading rate calculation unit 202 calculates the loading rate of load delivered by the same delivery means at a time based on the information about delivery. As described in the first example embodiment, as a premise of calculating the loading rate, it is assumed that which load is to be jointly delivered to the same delivery means at a time is determined based on the received delivery information. The delivery assistance system 20 may include a function unit for making this determination, or another device may include this function unit, and an implementation method is not particularly limited. As described in the first example embodiment, the method by which the loading rate calculation unit 202 calculates the loading rate may be performed using an existing technique, and is not particularly limited. In a case where the information about delivery includes the confirmed load amount, the loading rate calculation unit 202 calculates the loading rate of load loaded onto the same truck based on the confirmed load amount. Furthermore, the loading rate calculation unit 202 may calculate the loading rate for each consignor. The loading rate for each consignor is also referred to as a consignor loading rate. For example, the consignor loading rate may be a consignor loading rate of the load amount of the consignor with respect to the loading amount that can be loaded onto the truck that is the delivery means, or may be a consignor loading rate that is a ratio of the loading rate of the load of the consignor to the calculated entire loading rate, and is not particularly limited.

The assessment unit 203 assesses whether the calculated loading rate is equal to or more than a predetermined value.

Then, the determination unit 204 determines an incentive to a plurality of consignors in a case where the loading rate of the load loaded onto the same truck at a time is equal to or more a predetermined value. As described in the first example embodiment, the type of incentive may be different or the same for each consignor. As a result, an incentive is given when the loading rate is high.

### Example of Determining Same Incentive to Plurality of Consignors

As described in the first example embodiment, for example, the determination unit 204 may determine the same incentive to a plurality of consignors whose load is loaded onto the same truck at a time. For example, an incentive in a case where the loading rate of the load is equal to or more a predetermined value may be determined in advance. Specifically, for example, in a case where the loading rate of the load is an equal to or more predetermined value, the determination unit 204 determines a predetermined incentive to a plurality of consignors. The predetermined incentive may be represented in a table. For example, in a case where the loading rate of the load is equal to or more a predetermined value, the determination unit 204 may determine the same incentive to a plurality of consignors with reference to the table. Also in the following description, in a case where an incentive is predetermined, the predetermined incentive may be represented in a table, and the determination unit 204 may determine the incentive with reference to the table.

The incentive may be different depending on the season, the day of the week, or the like. For example, when the delivery means is a truck, the traffic volume varies depending on the season and the day of the week. Therefore, for example, the incentive in the season or the day of the week when the traffic volume is large may be set to be higher than the incentive in the season or the day of the week when the traffic volume is small.

The incentive may be determined according to the loading rate. For example, the higher the loading rate, the higher the incentive may be set. Specifically, for example, the incentive may be determined for each range of the loading rate. Taking a case where the incentive is a discount as an example, in a case where the predetermined value is 80%, the incentive in a case where the loading rate is 80% to 90% may be set to a discount of 1%, and the incentive in a case where the loading rate is equal to or more 90% may be set to a discount of 2%. In this manner, the determination unit 204 may determine the same incentive to a plurality of consignors based on the loading rate of load delivered by the same delivery means at a time.

### Example of Determining Incentive to Each Consignor

For example, the determination unit 204 may determine different incentives for a plurality of respective consignors.

Specifically, for example, the determination unit 204 determines an incentive to each of the plurality of consignors according to a consignor loading rate of load loaded onto the delivery means for each of the plurality of consignors. More specifically, for example, the determination unit 204 determines an incentive to each of the plurality of consignors in such a way that the consignor having a higher consignor loading rate obtains a higher incentive. For example, the incentive may be determined for each range of the consignor loading rate. Taking a case where the incentive is a discount as an example, in a case where the predetermined value is 80%, there is no incentive in a case where the consignor loading rate is equal to or more 0% and less than 10%, and the incentive in a case where the consignor loading rate is equal to or more 10% and less than 30% may be set as a 1% discount or the like. Then, the incentive in a case where the consignor loading rate is equal to or more than 30% and less than 60% may be set as a discount of 2%, and the incentive in a case where the consignor loading rate is equal to or more than 60% may be set as a discount of 3%. As in the exemplified numerical values, an incentive may not be provided to a consignor having a low consignor loading rate.

The predetermined incentive may be represented in a table in association with the consignor loading rate. For example, the determination unit 204 may determine the same incentive to each of the plurality of consignors according to the consignor loading rate for each of the plurality of consignors with reference to the table.

Alternatively, specifically, for example, the determination unit 204 determines an incentive to each of the plurality of consignors according to the date on which the predicted load amount has been received. More specifically, for example, the determination unit 204 determines an incentive to each of the plurality of consignors in such a way that the consignor in which the date on which the predicted cargo amount is received is earlier obtains a higher incentive. For example, an incentive may be determined in advance, such as one day, two days, one week, or two weeks before the delivery date.

The predetermined incentive may be represented in a table in association with the number of days from the delivery date to the received date. For example, the determination unit 204 may determine the same incentive to each of the plurality of consignors according to the date on which the predicted cargo amount for each of the plurality of consignors has been received with reference to the table.

Alternatively, specifically, for example, the determination unit 204 determines an incentive to each of the plurality of consignors according to a difference between the predicted load amount and the confirmed load amount. The determination unit 204 may determine the incentive to each of the plurality of consignors in such a way that the consignor in which the difference between the predicted load amount and the confirmed load amount is smaller obtains a higher incentive.

For example, an incentive may be determined in advance for each difference between the predicted load amount and the confirmed load amount. The predetermined incentive may be represented in a table in association with the difference. The determination unit 204 may determine the same incentive to each of the plurality of consignors according to the difference between the predicted load amount and the confirmed load amount for each of the plurality of consignors with reference to the table.

The description of the example of the method by which the determination unit 204 determines the incentive is terminated. The respective methods of determining the incentive by the determination unit 204 may be combined. For example, an example of determining the same incentive to a plurality of consignors and an example of determining an incentive to each consignor may be combined. For example, the determination unit 204 may determine the same incentive to a plurality of consignors as a basic incentive, and may further determine an incentive to each consignor as an additional incentive. For example, in a case where an incentive is determined for each consignor, the determination unit 204 may determine the incentive in such a way that the incentive is higher as the date on which the predicted load amount is received is earlier, the difference between the predicted load amount and the confirmed load amount is smaller, and the loading rate is larger. In an example of determining the same incentive to a plurality of consignors, in a case where the type of incentive is different for each consignor, the determination unit 204 may determine an equivalent incentive to the plurality of consignors.

The output control unit 205 presents an incentive. As described in the first example embodiment, the method by which the output control unit 205 presents an incentive is not particularly limited. An example in which the output control unit 205 displays an incentive on a display device of the terminal device 21 of the consignor will be described.

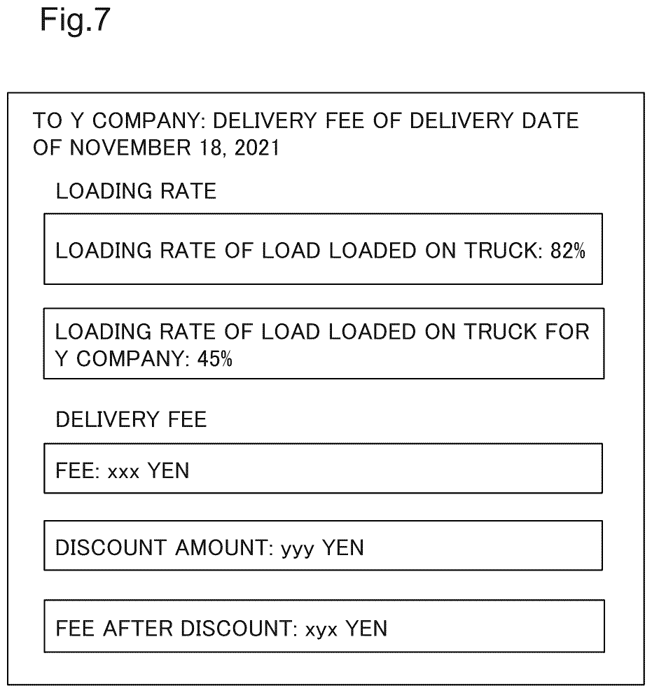

FIG. 7 is an explanatory diagram illustrating a display example of an incentive. For example, the output control unit 205 displays a screen including the loading rate, the loading rate of the consignor, and the incentive on the display device of the terminal device 21 of a consignor Y.

In FIG. 7, an incentive to Y company for joint delivery on the delivery date “Nov. 18, 2021” is presented. For example, in FIG. 7, the loading rate of the truck is 82%, and the loading rate of load loaded on the truck by Y company is 45%. According to FIG. 7, although the delivery fee is xxx yen, the discount amount as an incentive is yyy yen, and the fee after the discount is xyx yen.

Although not illustrated, for example, in a case where the loading rate is higher than the average loading rate, the output control unit 205 may present that there is a contribution to the joint delivery by the consignor, such as “there is a contribution”.

In a case where an incentive is determined according to the date on which the predicted load amount has been received, in a case where an incentive is determined according to a difference between the predicted load amount and the confirmed load amount, or the like, the output control unit 205 may output the date, the difference, or the like. That is, the output control unit 205 may output the reason why the incentive is given together with the incentive. As a result, the consignor can grasp the reason why the incentive is given. Therefore, motivation for cooperation in joint delivery can be improved.

Returning to the description of FIG. 5, the assignment unit 207 gives an incentive. The timing at which the incentive is given by the assignment unit 207 may be after the delivery is completed or before the delivery is completed, and is not particularly limited. For example, in a case where the incentive is a discount of the delivery fee, the assignment unit 207 may give an incentive at the time of payment of the delivery fee by the consignor.

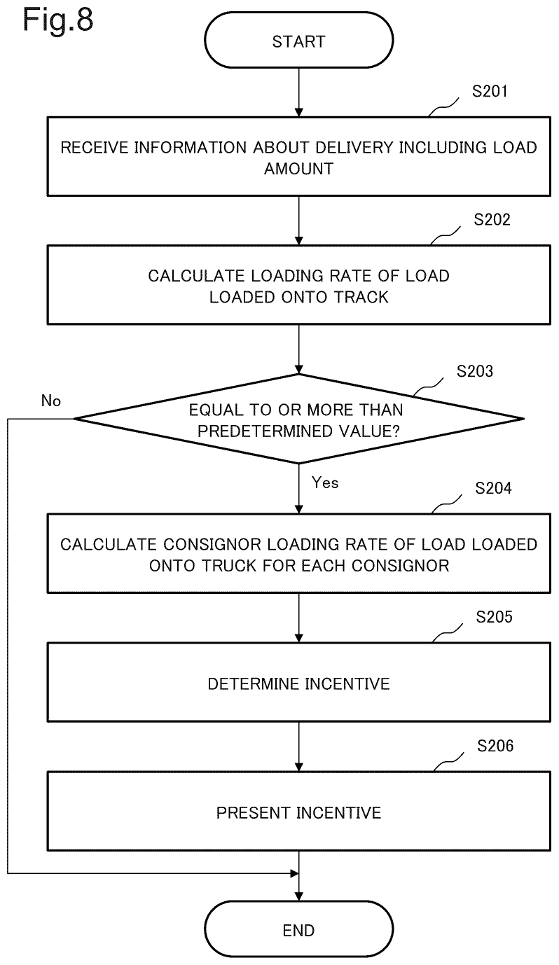

FIG. 8 is a flowchart illustrating an operation example of the delivery assistance system 20 according to the second example embodiment. An example in which an incentive is determined for each consignor according to a consignor loading rate of load loaded onto the same truck will be described.

The delivery acquisition unit 201 receives information about delivery including the load amount (step S201). In step S201, for example, the delivery acquisition unit 201 receives information about delivery including the load amount by the operation by the consignor via the terminal device 21 of the consignor.

Next, the loading rate calculation unit 202 calculates the loading rate of the truck (step S202). The assessment unit 203 assesses whether the loading rate of the load loaded on the truck is equal to or more than a predetermined value (step S203). In a case where the loading rate e on the truck is less than the predetermined value (step S203: No), the delivery assistance system 20 ends the process.

In a case where the loading rate of the truck is equal to or more than the predetermined value (step S203: Yes), the loading rate calculation unit 202 calculates the consignor loading rate of the load loaded on the truck for each consignor (step S204).

Next, the determination unit 204 determines an incentive to each consignor according to the consignor loading rate (step S205). In step S205, for example, the determination unit 204 may determine the incentive in such a way that the consignor having a higher consignor loading rate obtains a higher incentive. The presentation unit presents an incentive to each consignor (step S206). The delivery assistance system 20 ends the process.

As described above, in the second example embodiment, the delivery assistance system 20 calculates a loading rate of load delivered by the same delivery means based on information about delivery of load including the load amount, and presents an incentive to each of a plurality of consignors in a case where the calculated loading rate is equal to or more than a predetermined value. As a result, it is possible to promote participation in the joint delivery by presenting an easy-to-understand effect to the consignor.

The delivery assistance system 20 determines the same incentive to a plurality of consignors according to the loading rate of load loaded onto the delivery means. Since the same incentive is provided to each consignor, it is possible to promote participation in the joint delivery.

The delivery assistance system 20 calculates a consignor loading rate of load loaded onto the delivery means for each of the plurality of consignors, and determines an incentive to each consignor according to the consignor loading rate. For example, the delivery assistance system determines an incentive to each of the plurality of consignors in such a way that the consignor having a higher consignor loading rate obtains a higher incentive. As a result, it is possible to increase an incentive to a consignor who cooperates with the joint delivery. Therefore, it is possible to encourage a consignor with a large amount of load to participate in the joint delivery.

The delivery assistance system 20 determines an incentive to each of the plurality of consignors according to the date on which the predicted load amount has been received. When the predicted load amount is known early, it is easy to arrange the delivery means in joint delivery.

Therefore, for example, the delivery assistance system 20 determines an incentive to each of the plurality of consignors in such a way that the consignor in which the date on which the predicted cargo amount is received is earlier obtains a higher incentive. As a result, it is possible to increase an incentive to a more cooperative consignor in joint delivery. Therefore, it is possible to promote cooperation in joint delivery.

The delivery assistance system 20 determines an incentive to each of the plurality of consignors according to a difference between the predicted load amount and the confirmed load amount. For example, the delivery means may be arranged depending on the predicted load amount. For this reason, when the predicted load amount and the confirmed load amount are greatly different from each other, the arrangement plan of the delivery means is changed. Therefore, for example, the delivery assistance system 20 determines an incentive to each of the plurality of consignors in such a way that the consignor in which the difference between the predicted load amount and the confirmed load amount is smaller obtains a higher incentive. As a result, it is possible to increase an incentive to a more cooperative consignor in joint delivery. Therefore, it is possible to promote cooperation in joint delivery.

### <Incentive Based on Difference Between Delivery Fee at Time of Contract and Delivery Fee by Proportional Distribution Calculation>

Next, an example of giving an incentive by a difference between the cost at the time of contract and the actual cost in the joint delivery will be described.

For example, the distribution company wants the consignor to use the joint delivery, but it may be difficult some consignors to understand the effect of performing the joint delivery. A mechanism for giving an incentive to a cooperative consignor for joint delivery is provided. As a result, an easy-to-understand effect of the joint delivery is provided to the consignor while maintaining the contract regarding the joint delivery with consignor.

The delivery acquisition unit 201 acquires at least one of the load amount and the travel distance at the time of the joint delivery, and the total delivery fee required for the joint delivery from a database or the like. The load amount may be acquired for each consignor, for example. For example, the database may store, for each consignor, the consignor identification information, the identification information of the delivered load, the amount of the jointly delivered load, the identification information of the delivery means, and the like in association with each other. For example, the database may store, for each delivery, identification information of a delivery means, identification information of load, a travel distance, a cost required for the delivery, and the like in association with each other.

The proportional distribution calculation unit 206 calculates the proportion of the cost at the time of the joint delivery of each consignor by at least one of the load amount and the travel distance at the time of the joint delivery with reference to the above-described database. The proportional distribution calculation method may be performed using an existing technique, and is not particularly limited. The proportional distribution calculation unit 206 calculates the proportion for each consignor for each predetermined period. The predetermined period is a fixed period such as one month or half a year, or a period related to the contract period, and is not particularly limited. The period according to the contract period may be, for example, a period shorter than the contract period.

The determination unit 204 determines an incentive based on a difference between the delivery fee at the time of the contract with the consignor and the delivery fee calculated by the proportional distribution calculation. The incentive includes, for example, a point, a cashback, a discount of a delivery fee of the next contract, or the like, and not particularly limited.

The determination unit 204 may determine the incentive in a case where the delivery fee at the time of the contract with the consignor is larger than the delivery fee calculated by the proportional distribution calculation by a predetermined value or more. The predetermined value may be determined in advance, and is not particularly limited. The determination unit 204 may determine no incentive in a case where the delivery fee at the time of the contract with the consignor is larger than the delivery fee calculated by the proportional distribution calculation by less than a predetermined value. In this way, in a case where the delivery fee at the time of contract is too higher than the delivery fee actually charged by the joint delivery, an incentive is provided.

Specifically, for example, the determination unit 204 may determine the incentive in such a way that the larger the delivery fee at the time of the contract with the consignor is than the delivery fee calculated by the proportional distribution calculation, the higher the incentive.

The output control unit 205 presents an incentive to each consignor. A method by which the output control unit 205 presents an incentive to the consignor is not particularly limited. For example, as a method of presenting an incentive, the output control unit 205 may notify the consignor of the incentive using an electronic message, an electronic mail, or the like. Alternatively, as a method of presenting an incentive, the output control unit 205 may output an incentive to the terminal device 21 of the consignor. Specifically, for example, the output control unit 205 may display an incentive on a display device of the terminal device 21 of the consignor, for example. Alternatively, the output control unit 205 may output a voice to a voice output device of the terminal device 21 of the consignor, for example.

For example, a contract may be made between a consignor and a distribution company for joint delivery. Generally, a contract may be renewed at a particular time. When the consignor does not feel the merit of the joint delivery contract, the consignor may cancel the contract or change the contract at the time of renewal. Therefore, the output control unit 205 presents an incentive to the consignor before the next contract renewal time.

The assignment unit 207 gives an incentive. The timing at which the incentive is given by the assignment unit 207 is not particularly limited. For example, the timing at which the incentive is given by the assignment unit 207 may be before the contract is renewed or after the contract is renewed.

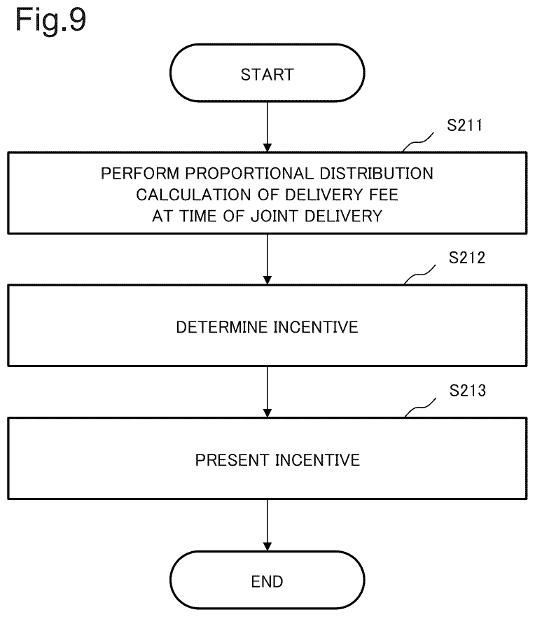

FIG. 9 is a flowchart illustrating another operation example by the delivery assistance system 20 according to the second example embodiment. The proportional distribution calculation unit 206 performs proportional distribution calculation of the delivery fee at the time of the joint delivery based on at least one of the load amount and the travel distance at the time of the joint delivery (step S211).

Next, the determination unit 204 determines an incentive based on a difference between the delivery fee at the time of the contract with the consignor and the delivery fee calculated by the proportional distribution calculation (step S212). Then, the output control unit 205 presents an incentive to the consignor (step S213).

As described above, in the second example embodiment, the delivery assistance system 20 determines an incentive based on a difference between the delivery fee at the time of the contract with the consignor and the delivery fee calculated by the proportional distribution calculation of the delivery fee at the time of the joint delivery, and presents the incentive to the consignor. As a result, it is possible to promote participation in the joint delivery. More specifically, it is possible to maintain the contract regarding the joint delivery with the consignor. It is possible to provide the consignor with an easy-to-understand effect by the joint delivery. When the joint delivery is more used and the loading rate is improved, the number of times of use of the delivery means with respect to the load amount can be reduced. Therefore, in a case where a delivery means that discharges carbon dioxide is used, it is possible to reduce the amount of carbon dioxide emission. Traffic congestion can be alleviated.

The delivery assistance system 20 presents an incentive to the consignor before the next contract renewal time. As a result, the consignor can confirm the effect of the joint delivery. Therefore, it is possible to further maintain the contract with the consignor regarding the joint delivery.

The description of each example embodiment ends. Each example embodiment may be modified and used.

### <First Modification>

In the first modification, an incentive may be further determined in consideration of the balance of the distribution company. For example, the determination unit 204 may determine the incentive in a case where the loading rate is equal to or more than a predetermined value and the revenue received by the distribution company is larger than the revenue received by the intermediate distributor by a threshold value or more.

The revenue received by the intermediate distributor is expenditure of the distribution company. That is, an incentive may be provided to the consignor in a case where a balance that is a difference between the revenue and the expenditure is sufficient.

The determination unit 204 may determine an incentive according to the balance of the distribution company. For example, the determination unit 204 may determine the incentive in such a way that the incentive is higher when the balance is large than when where the balance is small. Alternatively, the determination unit 204 may determine an incentive in such a way that the balance is equal to or more than a certain level. As a result, it is possible to provide an incentive according to the balance of the distribution company.

For example, even in a case where an incentive is determined based on a difference between the delivery fee at the time of the contract with the consignor and the delivery fee calculated by the proportional distribution calculation, the determination unit 204 may determine the incentive in consideration of the balance.

### <Second Modification>

When the loading rate is higher, the discharge amount of carbon dioxide can be reduced. Therefore, in the second modification, the effect of reducing the amount of carbon dioxide emission may be presented to the consignor. As a result, it is possible to encourage participation in further joint delivery.

For example, in the second modification, an emission amount calculation unit (not illustrated) may be further included. The emission amount calculation unit calculates an amount of carbon dioxide emission in the joint delivery. A method by which the emission amount calculation unit calculates the carbon dioxide emission amount may be performed using an existing technique such as a ton kilo method or a fuel method using multiplication of weight and distance is used, and is not particularly limited. The emission amount calculation unit calculates the total amount of carbon dioxide emission in a case where respective consignors have load delivered alone.

Then, for example, the output control unit 205 presents, to each consignor, a difference between the amount of carbon dioxide emission in the joint delivery and the total amount of carbon dioxide emission in a case where each consignor independently has load delivered as the reduction amount of the carbon dioxide emission amount.

### <Third Modification>

In the second example embodiment, an example in which an incentive is given in a case where the loading rate in the same delivery at a time is described. For example, in the third modification, an incentive may be provided in a case where the loading rates in respective deliveries may be calculated, and the average loading rate in the joint deliveries is high.

The period for which the average loading rate is calculated is a weekly unit, a monthly unit, a multi-month unit, a yearly unit, or the like, and not limited.

Specifically, for example, the assessment unit 203 assesses whether the average value of the loading rates in respective joint deliveries is equal to or more than a predetermined value. Then, the determination unit 204 determines an incentive in a case where the average value of the loading rates in respective joint deliveries is equal to or more than a predetermined value.

For example, an incentive may be determined before updating the contract for joint delivery. For example, in a case where an incentive is determined for each consignor, the incentive may be determined such a way that the incentive to the consignor cooperating with the joint delivery over a long period of time is high.

### <Fourth Modification>

For example, before delivery, an incentive in a case where at least part of the received information about delivery is changed may be presented.

Changing at least part of the received information about delivery, for example, changing the values of at least part of the items regarding delivery. More specifically, taking the time designation as an example, the value of the time designation is changed from the time designation “morning” to the time designation “afternoon”. For example, when the time designation is changed, there is a case where the combination of load for joint delivery is changed. Therefore, the loading rate may be increased.

Specifically, for example, the loading rate calculation unit 202 may calculate the loading rate in a case where part of the received information about delivery is changed.

The assessment unit 203 assesses whether the loading rate in a case where at least part of the received information about delivery is changed is equal to or more than a predetermined value. As described above, the predetermined value is not particularly limited. For example, the predetermined value may be a loading rate in a case where the received information about delivery is not changed. That is, the delivery assistance system 20 may be configured to present an incentive in a case where the loading rate is increased by changing at least part of the information about delivery.

Then, the determination unit 204 determines an incentive in a case where the loading rate in a case where at least part of the received information about delivery is changed is equal to or more than a predetermined value.

Then, the output control unit 205 presents an incentive in a case where the loading rate in a case where at least part of the received information about delivery is changed is equal to or more than a predetermined value.

The output control unit 205 may present an incentive in a case where at least part of the received information about delivery is changed and an incentive in a case of the received information about delivery in a comparable manner. As an example of presenting the incentive in a comparable manner, the output control unit 205 may display these incentives side by side. In a case where an incentive in a case where at least part of the received information about delivery is changed is higher than an incentive in a case of the received information about delivery, the output control unit 205 may present these incentives in a comparable manner.

For example, before delivery, the consignor may confirm an incentive and accept some changes. For example, the delivery acquisition unit 201 may receive a partial change by the operation by the consignor. That is, the delivery acquisition unit 201 newly acquires information about delivery of the load. As a result, the loading rate can be improved.

### <Fifth Modification>

In a case where an incentive is determined in advance, while an example in which the incentive is represented by a table is described, a function that can determine an incentive may be prepared in advance. Taking a case where the same incentive is given to a plurality of consignors based on the loading rate as an example, a function that outputs an incentive when the loading rate is input may be prepared in advance. Then, the determination unit 204 inputs the calculated loading rate to the function, and determines an incentive output from the function as an incentive to be given to a plurality of consignors. A function may be similarly used in an example of determining another incentive.

The description of each modification is ended. Each example embodiment and each modification may be used in combination. For example, in each example embodiment, the delivery assistance system may include part of each function unit and information. For example, the delivery assistance system may include a proportional distribution calculation unit, a determination unit, and an output control unit.

For example, the delivery assistance system may include a delivery acquisition means, a loading rate calculation unit, a determination unit, and an output control unit. In the case of such a configuration, the delivery acquisition unit acquires information about delivery of load including the load amount from each of a plurality of consignors. The loading rate calculation unit calculates the loading rate of load delivered by the same delivery means at a time based on the information about delivery. Then, the determination unit determines an incentive to a plurality of consignors according to the calculated loading rate. The output control unit presents the determined incentive.

Each example embodiment is not limited to the above-described example, and various modifications can be made. The configuration of the delivery assistance system in each example embodiment is not particularly limited. For example, the delivery assistance system may be achieved by one terminal device and one device such as one server. Alternatively, the delivery assistance system may be achieved by a different device for each function or data. For example, the delivery assistance system may include a plurality of servers.

In each example embodiment, each piece of information may include part of the information described above. Each piece of information may include information other than the above-described information. Each piece of information may be divided into a plurality of tables or a plurality of pieces of information in more detail. As described above, a method of achieving each piece of information is not particularly limited.

Each screen displayed on the display device of the terminal device of the consignor is an example, and is not particularly limited. In each screen, a button, a list, a checkbox, an information display field, an input field, and the like (not illustrated) may be added. The background color of the screen and the like may be changed.

For example, in each example embodiment, the processing of generating information of a screen or the like to be displayed on a display device of a terminal device of a consignor may be performed by an output control unit of the delivery assistance system. This process may be performed by a terminal device of a consignor.

### Hardware Configuration Example of Computer

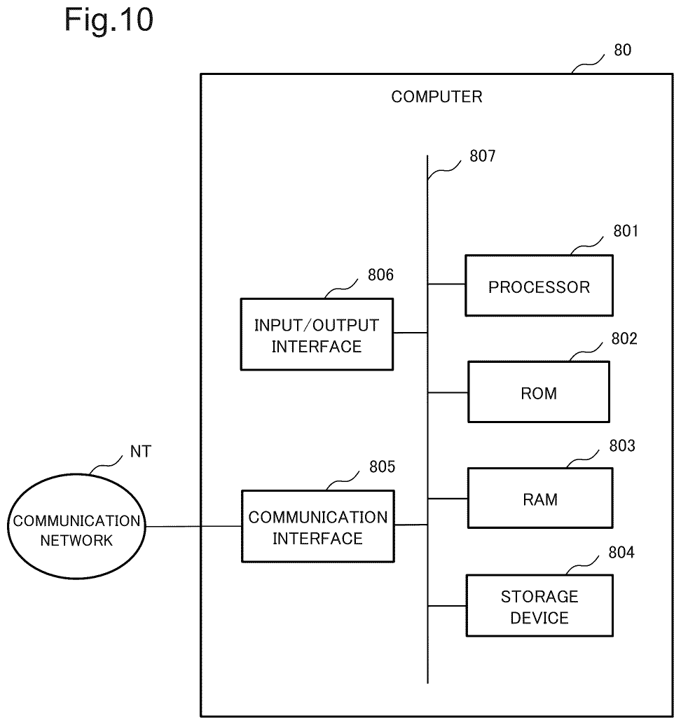

Next, a hardware configuration example in a case where each device such as the delivery assistance system and the terminal device described in each example embodiment is implemented by a computer will be described. FIG. 10 is an explanatory diagram illustrating a hardware configuration example of a computer. For example, some or all of the devices can be achieved by using an any combination of a computer 80 and the program as illustrated in FIG. 10, for example.

The computer 80 includes, for example, a processor 801, a read only memory (ROM) 802, a random access memory (RAM) 803, and a storage device 804. The computer 80 includes a communication interface 805 and an input/output interface 806. The components are connected via, for example, a bus 807. The number of units in each component is not particularly limited, and the number of units is one or more.

The processor 801 controls the entire computer 80. Examples of the processor 801 include a central processing unit (CPU), a digital signal processor (DSP), and a graphics processing unit (GPU). The computer 80 includes a ROM 802, a RAM 803, a storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801.

The processor 801 loads a program stored in the storage device 804, the ROM 802, or the like. Then, the processor 801 executes each process coded in the program. The processor 801 may download various programs via the communication network NT. The processor 801 functions as part or all of the computer 80. Then, the processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. Then, the communication interface 805 controls an input/output of data from an external device or an external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that outputs sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 10. The computer 80 may have components other than those illustrated in FIG. 10. For example, the computer 80 may include a drive device or the like.

Then, the processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited.

The description of the hardware configuration of each device ends. There are various modifications in a method of achieving each device. For example, each device may be achieved by an any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computers, circuits, and the like, the plurality of computers, circuits, and the like may be disposed in a centralized manner or in a distributed manner.

The delivery assistance method described in each example embodiment is implemented by the delivery assistance system. For example, the delivery assistance method is implemented by a computer such as a server or a terminal device executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. The program may be distributed via the communication network NT.

The function of each component of the delivery assistance system in each example embodiment described above may be implemented by hardware as in a computer. Alternatively, each component may be achieved by a computer or firmware based on program control.

While the present disclosure has been described with reference to each of example embodiments, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### (Supplementary Note 1)

A delivery assistance system including
a delivery acquisition means for acquiring, from each of a plurality of consignors, information about delivery of load including a load amount,
a loading rate calculation means for calculating a loading rate of load delivered by a same delivery means at a time based on the information about delivery,
an assessment means for assessing whether the calculated loading rate is equal to or more than a predetermined value,
a determination means for determining an incentive to the plurality of consignors in a case where the loading rate is equal to or more than the predetermined value, and
an output control means for presenting the determined incentive.

### (Supplementary Note 2)

The delivery assistance system according to Supplementary Note 1, wherein
the determination means determines a same incentive to the plurality of consignors based on the loading rate.

### (Supplementary Note 3)

The delivery assistance system according to Supplementary Note 1, wherein
the loading rate calculation means calculates a loading rate of load loaded onto the delivery means for each of the plurality of consignors, and
the determination means determines an incentive to each of the plurality of consignors according to the loading rate for each of the plurality of consignors.

### (Supplementary Note 4)

The delivery assistance system according to Supplementary Note 3, wherein the determination means determines an incentive to each of the plurality of consignors in such a way that the higher the loading rate for each of the plurality of consignors is, the higher an incentive is.

### (Supplementary Note 5)

The delivery assistance system according to Supplementary Note 1, wherein
the information about delivery includes a predicted load amount, and
the determination means determines an incentive to each of the plurality of consignors according to a date when the predicted load amount is received.

### (Supplementary Note 6)

The delivery assistance system according to Supplementary Note 5, wherein
the determination means determines an incentive to each of the plurality of consignors in such the earlier a date when the predicted load amount is received is, a way that the higher an incentive is.

### (Supplementary Note 7)

The delivery assistance system according to Supplementary Note 1, wherein
the information about delivery includes a predicted load amount and a confirmed load amount, and
the determination means determines an incentive to each of the plurality of consignors according to a difference between the predicted load amount and the confirmed load amount.

### (Supplementary Note 8)

The delivery assistance system according to Supplementary Note 7, wherein
the determination means determines an incentive to each of the plurality of consignors in such a way that the smaller a difference between the predicted load amount and the confirmed load amount is, the higher an incentive is.

### (Supplementary Note 9)

The delivery assistance system according to any one of Supplementary Notes 1 to 8, wherein
the incentive is at least any one of a discount of a current delivery and a discount of a next delivery.

### (Supplementary Note 10)

The delivery assistance system according to any one of Supplementary Notes 1 to 9, wherein
the delivery means includes a truck.

### (Supplementary Note 11)

A delivery assistance method including
acquiring, from each of a plurality of consignors, information about delivery of load including a load amount,
calculating a loading rate of load delivered by a same delivery means at a time based on the information about delivery,
assessing whether the calculated loading rate is equal to or more than a predetermined value,
determining an incentive to the plurality of consignors in a case where the loading rate is equal to or more than the predetermined value, and
presenting the determined incentive.

### (Supplementary Note 12)

A non-transitory computer-readable recording medium recording a program for causing a computer to execute the steps of
acquiring, from each of a plurality of consignors, information about delivery of load including a load amount,
calculating a loading rate of load delivered by a same delivery means at a time based on the information about delivery,
assessing whether the calculated loading rate is equal to or more than a predetermined value,
determining an incentive to the plurality of consignors in a case where the loading rate is equal to or more than the predetermined value, and
presenting the determined incentive.

### (Supplementary Note 13)

A program for causing a computer to execute the steps of
acquiring, from each of a plurality of consignors, information about delivery of load including a load amount,
calculating a loading rate of load delivered by a same delivery means at a time based on the information about delivery,
assessing whether the calculated loading rate is equal to or more than a predetermined value,
determining an incentive to the plurality of consignors in a case where the loading rate is equal to or more than the predetermined value, and
presenting the determined incentive.

### REFERENCE SIGNS LIST

10, 20 delivery assistance system
21, 21-1, 21-2 terminal device
101, 201 delivery acquisition unit
102, 202 loading rate calculation unit
103, 203 assessment unit
104, 204 determination unit
105, 205 output control unit
206 proportional distribution calculation unit
207 assignment unit
2001 load DB
80 computer
801 processor
802 ROM
803 RAM
804 storage device
805 communication interface
806 input/output interface
807 bus
NT communication network
A, B, C, Y consignor

What is claimed is:

1. A delivery assistance system comprising:
At least one memory storing instructions; and
at least one processor configured to execute the instructions to:
acquire, from each of a plurality of consignors, information about delivery of load including a load amount;
calculate a loading rate of load delivered by a same delivery means at a time based on the information about delivery;
assess whether the calculated loading rate is equal to or more than a predetermined value;
determine an incentive to the plurality of consignors in a case where the loading rate is equal to or more than the predetermined value; and
output the determined incentive.

2. The delivery assistance system according to claim 1, wherein the at least one processor is further configured to execute the instructions to:
determine a same incentive to the plurality of consignors based on the loading rate.

3. The delivery assistance system according to claim 1, wherein the at least one processor is further configured to execute the instructions to:
calculate a loading rate of load loaded onto the delivery means for each of the plurality of consignors, and
determine an incentive to each of the plurality of consignors according to the loading rate for each of the plurality of consignors.

4. The delivery assistance system according to claim 3, wherein the at least one processor is further configured to execute the instructions to:
determine an incentive to each of the plurality of consignors in such a way that the higher the loading rate for each of the plurality of consignors is, the higher an incentive is.

5. The delivery assistance system according to claim 1, wherein
the information about delivery includes a predicted load amount, and wherein the at least one processor is further configured to execute the instructions to:
determine an incentive to each of the plurality of consignors according to a date when the predicted load amount is received.

6. The delivery assistance system according to claim 5, wherein the at least one processor is further configured to execute the instructions to:
determine an incentive to each of the plurality of consignors in such a way that the earlier a date when the predicted load amount is received is, the higher an incentive is.

7. The delivery assistance system according to claim 1, wherein
the information about delivery includes a predicted load amount and a confirmed load amount, wherein the at least one processor is further configured to execute the instructions to:
determine an incentive to each of the plurality of consignors according to a difference between the predicted load amount and the confirmed load amount.

8. The delivery assistance system according to claim 7, wherein the at least one processor is further configured to execute the instructions to:
determine an incentive to each of the plurality of consignors in such a way that the smaller a difference between the predicted load amount and the confirmed load amount is, the higher an incentive is.

9. The delivery assistance system according to claim 1, wherein
the incentive is at least any one of a discount of a current delivery and a discount of a next delivery.

10. The delivery assistance system according to claim 1, wherein
the delivery means includes a truck.

11. A delivery assistance method comprising:
acquiring, from each of a plurality of consignors, information about delivery of load including a load amount;
calculating a loading rate of load delivered by a same delivery means at a time based on the information about delivery;
assessing whether the calculated loading rate is equal to or more than a predetermined value;
determining an incentive to the plurality of consignors in a case where the loading rate is equal to or more than the predetermined value; and
presenting the determined incentive.

12. A non-transitory computer-readable recording medium recording a program for causing a computer to execute the steps of:
acquiring, from each of a plurality of consignors, information about delivery of load including a load amount;
calculating a loading rate of load delivered by a same delivery means at a time based on the information about delivery;
assessing whether the calculated loading rate is equal to or more than a predetermined value;
determining an incentive to the plurality of consignors in a case where the loading rate is equal to or more than the predetermined value; and
presenting the determined incentive.
